(19) United States
(12) Patent Application Publication
(10) Pub. No.: US 2009/0292058 A1
(43) Pub. Date: Nov. 26, 2009

(54) Aqueous Polymer Compositions Exhibiting Increased Open Time With Reduced Levels Of Volatile Organic Compounds

(75) Inventors: Yvonne Aileen Berry-Walker, Elkhorn, WI (US); Joel Schroeder, Racine, WI (US); Arron M. Strepka, LaGrange Park, IL (US); Jason Butt, Oak Park, IL (US); Makarand Joshi, Grayslake, IL (US); William D. Arendt, Libertyville, IL (US)

Correspondence Address: FITCH EVEN TABIN & FLANNERY, 120 SOUTH LASALLE STREET, SUITE 1600, CHICAGO, IL, 60603-3406, US

(73) Assignee: VELSICOL CHEMICAL CORPORATION, Rosemont, IL (US)

(21) Appl. No.: 12/126,397

(22) Filed: May 23, 2008

(51) Int. Cl. C08K 3/20

(52) U.S. Cl. 524/501

(57) ABSTRACT

In addition to acting as effective plasticizers, certain acid, carboxylate and hydroxyl-functional liquid polyesters that are liquid at 25° C. can be used as at least partial replacements for the more volatile organic compounds conventionally used as coalescents and/or property enhancers in aqueous film-forming compositions. The resultant compositions exhibit reduced VOC values relative to prior art compositions exhibiting comparable levels of application and coating properties.

### FIELD OF THE INVENTION

This invention relates to aqueous film-forming polymer compositions. More particularly, this invention relates to compositions containing relatively low levels of volatile organic compounds (VOC's) wherein 1) particles of a film-forming polymer are able to coalesce at temperatures below the glass transition temperature of the polymer; 2) the compositions are resistant to gelation during repeated cycles of freezing and thawing; and 3) the open times of the compositions are increased. These objectives are achieved by at least partially replacing volatile prior art additives with the considerably less volatile polyesters of the present invention. The compositions include but are not limited to coatings (including paints), self-supporting films, adhesives, sealants, inks, overprint varnishes, caulks and similar polymer compositions.

### RELATED PRIOR ART

The use of polyesters as plasticizers for a variety of organic polymer compositions is well known. Patents disclosing this use include U.S. Pat. No. 6,933,337, issued to Lang et al. The polyesters described in this patent contain non-reactive terminal units and are prepared using monofunctional alcohols and/or carboxylic acids in addition to the dicarboxylic acid(s), diethylene glycol and at least one additional diol.

U.S. Pat. No. 6,111,004 to Biesiada et al. discloses polyester plasticizers for polyvinyl chloride derived from a propanediol and a linear aliphatic dicarboxylic acid containing from 6 to 14 carbon atoms. The polyesters are terminated with monocarboxylic acids and therefore do not contain functional terminal groups.

The use of polyesters with functional or non-functional terminal units as plasticizers for a variety of polymers, including but not limited to polyvinyl chloride, is described in the following U.S. Pat. Nos. 5,281,647; 7,135,524; 4,436,784 to Earhart, 3,194,776 to Caldwell, and 4,272,428 to Lindner et al. The polyesters of the Caldwell patent can be used in either oil- or water-based paints.

An article by Azim et al that appeared in Polymer International, 47(3); 303-10 (1998) contains comparative physical property evaluations for a number of functionally terminated polyesters used as plasticizers for polyvinyl chloride.

Aqueous polymer compositions employed, for example, as coatings, inks, adhesives, caulks and sealants typically require the presence of relatively volatile organic compounds such as alcohols, glycols, esters and glycol ethers to achieve desirable properties. These properties include but are not limited to open time, wet edge development, the ability of the particles of film-forming polymer to coalesce at temperatures below the glass transition temperature of the polymers, the resistance to gelation of the composition during repeated cycles of freezing and thawing and the adhesion, leveling, toolability, gloss development, and the resistance to scrubbing and organic solvents exhibited by films and coatings applied using the compositions.

Recently several national and regional governments have issued restrictions concerning the amounts of volatile organic compounds (VOC's) that can be present in compositions intended for use as coatings, inks, sealants, adhesives and related applications. These restrictions have initiated efforts by manufactures and formulators of these compositions to seek ways to eliminate or at least reduce the concentration of VOC's in both aqueous and non-aqueous polymer compositions without adversely affecting the beneficial properties imparted by these compounds.

U.S. Pat. No. 6,762,230, which issued to L. Brandenburger et al. teaches lowering the V.O.C. level in aqueous coating compositions containing latex polymers by replacing conventional coalescents such as Texanol® (2,2,4-trimethyl-1,3-pentanediol monoisobutyrate) with relatively low molecular weight reaction products of 1) lactones with monohydric alcohols or 2) glycidyl esters with monocarboxylic acids. Coating compositions containing these reaction products exhibited lower V.O.C. values than a coating prepared using Texanol®. When evaluated for scrubability, coatings containing a polyester of this invention and Texanol® were equivalent.

U.S. Pat. No. 5,236,987, which issued to William D. Arendt on Aug. 17, 1993 teaches using benzoic acid esters of monohydric alcohols containing from 8 to 12 carbon atoms as replacements for conventional coalescents for aqueous coating compositions. Latex paint compositions containing isodecyl benzoate as the coalescent exhibited scrub resistance values that were at least equivalent to ones containing Texanol®. The V.O.C. content of isodecyl benzoate is about 22%.

U.S. Pat. No. 6,794,434 to Collins et al. teaches using surfactants as replacements for volatile co-solvents in water-based paints.

U.S. Pat. No. 5,422,392 to Floyd teaches eliminating relatively volatile organic coalescing solvents in aqueous coating compositions by polymerizing a film-forming polymer such as polyvinyl acetate in the presence of a relatively low molecular weight oligomer such as a polyester. The polyester can contain functional or non-functional terminal units. The number average molecular weight of these oligomers is from 300 and 10,000. The degree of polymerization of these oligomers is between 2 and 100, most preferably between 2 and 20.

U.S. Pat. No. 7,217,758 to Buckmann et al. describes aqueous coating compositions with extended open times. The compositions contain a dispersed film-forming polymer and a crosslinkable oligomer that can be used in combination with a non-crosslinkable oligomer. The oligomers must comply with a complex mathematical formula that involving a number of factors that affect the viscosity of the continuous phase in the drying piant film, and hence the open time of the coating composition.

U.S. Pat. No. 7,144,945 to Martin et al. describes aqueous coating compositions with extended open times. The compositions contain a non-crosslinkable water-dispersible oligomer, a dispersed film-forming polymer and an optional co-solvent. The compositions have open times of at least 20 minutes, wet-edge times of at least 10 minutes, tack-free times of at less than 24 hours and equilibrium viscosities of 5,000 poise. Preferred oligomers are water dispersible and include polyethylene oxides and oligomers containing groups that are water dispersible or that can be reacted with and acid or base to make them water-dispersible. The oligomer can be linear or branched. Suitable oligomers include polyurethanes, polyesters and vinyl polymers. The six exemplified oligomers include only one linear polyester, which is prepared from adipic acid and butanediol and exhibits an acid number of 40 mg. KOH/g. This polyester is not evaluated in any of the disclosed paint compositions.

One objective of this invention is to replace the relatively volatile coalescents of the prior art with less volatile polyesters. One apparent disadvantage of this approach is that the resultant higher concentration of the less volatile coalescents in the final product such as a coating or sealant would be expected to adversely affect physical properties such as resistance to scrubbing and solvents.

A second objective is to reduce the VOC level of aqueous polymer compositions by reducing the concentration of prior art volatile organic compounds such as ethylene and propylene glycol required to achieve a given level of film properties and package stability, a term used in this specification to include heat stability and resistance to gelation of the polymer composition during cycles of freeze and thawing.

The present invention is based on the discovery that certain functionally terminated liquid polyesters can be used as at least partial replacements for the more volatile organic compounds conventionally used to enhance performance in aqueous coatings and other types of aqueous polymer compositions. In addition to being effective plasticizers, these polyesters extend open time, improve package stability and promote coalescence of aqueous polymer compositions at relatively low levels of volatile organic compounds. Using preferred polyesters, the levels of desirable coating properties achieved, such as resistance to scrubbing and solvents, are at least equivalent to the properties of coatings prepared using compositions containing significantly higher concentrations of these volatile organic compounds.

### SUMMARY OF THE INVENTION

This invention provides low- or zero VOC aqueous film-forming compositions exhibiting properties characteristic of compositions with higher VOC levels, said compositions comprising

A. at least one emulsified or dispersed film-forming organic polymer;

B. as a plasticizing and property improving additive, from 1 to 200 weight percent, based on said organic polymer, of a polyester exhibiting a weight average molecular weight of from 1,000 to 100,000 and including repeating units of the general formula —OR¹O(O)CR²C(O)— and terminal units of at least one general formula selected from the group consisting of —O(O)CR²C(O)OX and —OR¹OH, wherein R¹ is at least one member selected from the group consisting of linear and branched alkylene radicals containing from 2 to 10 carbon atoms and —(R³O)ₙR³—, R² is at least one member selected from the group consisting of linear and branched alkylene radicals containing from 1 to 10 carbon atoms, and the isomeric phenylenes; R³ is at least one member selected from the group consisting of linear and branched alkylene radicals containing from 2 to 8 carbon atoms, X is selected from the group consisting of hydrogen, an alkali metal or NH₄⁺, and n is an integer from 1 to 4, inclusive; and

C. water;

wherein the properties enhanced by said additive comprise extended open time, wet edge stability, package stability, the ability of liquid films formed from said compositions to coalesce at temperatures at or below the minimum film-forming temperature of said organic polymer and enhancement of the application properties of said composition.

In preferred embodiments of the present polyesters, R¹ contains from 4 to 8 carbon atoms, R³ contains 2 or 3 carbon atoms, n is 2 or 3 and the terminal units of the polyesters are —O(O)CR²C(O)OH.

As used in this specification the term “package stability” is defined as the combination of heat stability of the coating composition in its container and the resistance of this composition to gelling during repeated cycles of freezing and thawing.

Organic polymers suitable for use with the present compositions include but are not limited to homopolymers and copolymers of acrylic and methacrylic acid esters, copolymers of acrylic and methacrylic acid esters thereof with styrene, vinyl monomers and ethylene, vinyl acetate/ethylene copolymers, polyurethanes, epoxide polymers, epoxide-modified acrylic polymers, and mixtures containing two or more of the aforementioned polymers. In preferred embodiments of the present compositions the film-forming polymer is selected from the group consisting of acrylic, vinyl/acrylic copolymers, styrenated acrylic polymers, polyvinyl acetate and vinyl acetate/ethylene copolymers.

### DETAILED DESCRIPTION OF THE INVENTION

The liquid polyesters of this invention are suitable modifiers for a variety of aqueous polymer compositions, including but not limited to coating compositions, caulks, inks, adhesives, overprint varnishes, sealants, compositions capable of forming self-supporting films and similar compositions. In addition to the present liquid polyesters the polymer compositions include at least one emulsified or dispersed film-forming organic polymer, water, and, typically, one or more water-miscible organic compounds whose functions include but are not limited to coalescents, surfactants, and film modifiers.

The present liquid polyesters at least partially replace more volatile organic additives used to enhance the application properties of aqueous coating compositions, including but not limited to as wet-edge and open time, and to improve package stability. Conventional prior art additives are typically volatile liquid organic compounds and include but not limited to ethylene glycol and propylene glycol.

The present polyesters also at least partially replace more volatile organic coalescents, including the benzoates of monohydric alcohols described in the aforementioned Arendt patent. Conventional prior art organic coalescents include but are not limited to esters of alcohols, glycols and ethers. Preferred coalescents are esters of aliphatic diols such as Texanol® and Texanol® isobutyrate.

The present functionally terminated polyesters will now be described in detail. In the foregoing formulae for the repeating units of the present polyesters R¹ is at least one member selected from the group consisting of linear and branched alkylene radicals containing from 2 to 10, preferably from 4 to 8, carbon atoms and —(R³O)ₙR³—, R² is at least one member selected from the group consisting of linear and branched alkylene radicals containing from 1 to 10 carbon atoms and the three isomeric phenylene radicals, R³ is at least one member selected from the group consisting of alkyl radicals containing from 2 to 8, preferably 2 or 3, carbon atoms, X is hydrogen, an alkali metal or NH₄⁺, and n is an integer from 2 to 4, inclusive, preferably 2 or 3.

Preferably R¹ contains from 4 to 8 carbon atoms, R² is selected from the group consisting of linear alkylene containing from 4 to 8 carbon atoms and the isomeric phenylenes, and R³ is ethylene or isopropylene.

The weight average molecular weight of the present polyester plasticizer/coalescents is between 1,000 and 100,000, preferably between 3,000 and 6,000. The molecular weight of the polyesters and the type of functional terminal units (hydroxyl or carboxyl) are typically controlled by adjusting the molar ratio of dicarboxylic acid(s) to dihydric alcohol(s) use to prepare the polymers.

Carboxyl terminal units are preferred. Carboxylate-terminated polyesters can be prepared by reacting a carboxyl-terminated polyester with an alkali metal hydroxide or ammonium hydroxide.

Carboxyl-terminated polyesters typically have acid numbers of from 1 to 40 mg. of KOH per gram of polyester. Hydroxyl-terminated polyesters typically exhibit hydroxyl numbers of from 5 to 60 mg. of KOH/gram of polyester.

The present oligomeric polyesters can be prepared using any of the types of reactions typically used to prepare relatively low molecular weight functionally terminated polyesters. Procedures for preparing and isolating liquid polyesters are well know and sufficiently described in the prior art relating to these polymers that a more detailed procedure for preparing these. Methods for preparing the functionally terminated polyesters of this invention by the reaction of at least one diol or glycol with at least one dicarboxylic acid or suitable derivative thereof in the presence of a suitable esterification catalyst are known to those skilled in this art.

### Aqueous Polymer Compositions

The oligomeric carboxyl-, carboxylate and hydroxyl-terminated polyesters of this invention are suitable as performance enhancers in a variety of aqueous polymer compositions, including but not limited to coatings, sealants, adhesives and inks. In addition to a dispersed film-forming polymer and one or more of the present polyesters these compositions typically contain a variety of the aforementioned relatively volatile organic compounds that either impart or modify properties of the coating composition and/or films formed from the compositions.

The accompanying examples demonstrate that the polyesters of this invention extend the open time of latex paints with a VOC level of 0 to a greater extent than organic compounds and benzoic acid esters exhibiting substantial VOC values.

Organic polymers suitable for use as the film-forming ingredient in the aqueous compositions of the present invention include but are not limited to homopolymers and copolymers of acrylic and methacrylic acid esters, copolymers of these esters with styrene, vinyl monomers, and ethylene; vinyl acetate-ethylene copolymers, polyurethanes, epoxide polymers, epoxy-modified acrylic polymers, and mixtures of two or more of the aforementioned polymers.

The end use applications of the aqueous polymer compositions of the present invention include but are not limited to coating materials including but not limited to paints and industrial coatings, adhesives, sealants, over-print varnishes, caulks, inks, and self-supporting films.

The polyesters of this invention typically constitute from about 1 to about 200 weight percent, preferably from 1 to 50 weight percent, based on the weight of film-forming polymers in the polymer composition. When preparing pigmented coating compositions such as paints, the polyesters of this invention are preferably blended together with the pigment and other solid ingredients to produce a more stable dispersion in the final composition.

The following examples describe preferred aqueous coating compositions containing a preferred polyester of this invention and the ability of this polyester to partially replace more volatile organic compounds typically used as coalescents, film property enhancers and to achieve package stability of coating compositions. The examples should not be interpreted as limiting the scope of operable liquid polyesters and film-forming compositions encompassed by the accompanying claims. Unless otherwise indicated all parts and percentages in the examples are by weight and properties were measured at 25° C.

### EXAMPLE 1

This example demonstrates the increase in open time values achieved when a polyester of this invention was added as a plasticizer/coalescent to four different commercial water-based latex paints. All of the commercial paint compositions evaluated are advertised as containing substantially no V.O.C.s.

The acid-functional polyester used is the reaction product of adipic acid and diethylene glycol exhibiting an acid number of 28. This polyester is identified as additive 1 in the following table.

The open time values of all of the paints were determined by applying the each composition individually using a 3 inch-wide brush with vertical strokes onto a paper substrate available as “BH chart” from Lenetta. Immediately following application of the paints the figure “X” was inscribed on each paint sample using the handle of the brush and a timer was started. At predetermined time intervals the brush is rewetted with the paint and a horizontal stripe is painted across the “X”. The longest interval following which the portion of the already applied paint layer immediately adjacent to the “X” can be blended in with the newly applied paint is referred to as the “open time”.

| | | | OPEN | |
|---|---|---|---|---|
| COMMERCIAL | | | TIME | Δ FROM |
| PAINT | % ADDITIVE | ADDITIVE | (S) | CONTROL |
| A | 0 | None | 390 | |
| | 3.75 | 1 | 420 | 30 |
| | | 2c | 360 | −30 |
| | | 3c | 360 | −30 |
| | | 4c | 360 | −30 |
| | 7.5 | 1 | 450 | 60 |
| | | 2c | 420 | 30 |
| | | 3c | 420 | 30 |
| | | 4c | 420 | 30 |
| B | 0 | None | 420 | |
| | 3.75 | 1 | 510 | 90 |
| | | 2c | 495 | 75 |
| | | 3c | 420 | 0 |
| | | 4c | 555 | 135 |
| | 7.5 | 1 | 420 | 0 |
| | | 2c | 420 | 0 |
| | | 3c | 360 | −60 |
| | | 4c | 505 | 85 |
| C | 0 | None | 135 | |
| | 3.75 | 1 | 195 | 60 |
| | | 2c | 30 | −105 |
| | | 3c | 60 | −75 |
| | | 4c | 30 | −105 |
| | 7.5 | 1 | 240 | 105 |
| | | 2c | 30 | −105 |
| | | 3c | 30 | −105 |
| | | 4c | 30 | −105 |
| D | 0 | None | 150 | |
| | 3.75 | 1 | 195 | 45 |
| | | 2c | 30 | −120 |
| | | 3c | 90 | −60 |
| | | 4c | 30 | −120 |
| | | | | −45 |
| | 7.5 | 1 | 105 | −45 |
| | | 2c | 30 | −120 |
| | | 3c | 30 | −120 |
| | | 4c | 30 | −120 |

Additives:
1. a diethylene glycol/adipic acid copolymer exhibiting an acid number of 28
2c a 1/1 weight ratio mixture of diethylene glycol dibenzoate and dipropylene glycol dibenzoate
3c the dibenzoate of a 200 molecular weight polyethylene glycol
4c triethylene glycol bis(2-ethyl hexanoate)

The commercial paints are designated as follows:

A=Sherwin Williams, Zero VOC, ethylene-vinyl acetate copolymer, interior flat
B=Dulux Zero VOC, 100% acrylic latex, interior semi-gloss
C=Pittsburgh Paints, Zero VOC, 100% acrylic latex, interior flat
D=Pittsburgh Paints, Zero VOC, 100% acrylic latex, interior semi-gloss

The data in Table 1 demonstrate that in 6 of the 8 formulations evaluated the presence of the acid-terminated polyester of this invention increased the open time of the formulation by up to 105 seconds relative to the unmodified control. In only one instance, namely in the Pittsburgh Paints Interior Semi-Gloss did the presence of the polyester at the higher level of 7.5 weight percent have an adverse effect on the open time of the unmodified composition. Only in the Dulux® paint did the prior art coalescent, in this instance triethylene glycol bis(2-ethyle hexanoate) provide a longer open time than the polyester of this invention.

### EXAMPLE 2

This example compares the volatile content of traditional additives for coating compositions with the volatile content of an acid-functional polyester additive of this invention. The volatile contents were determined using ASTM test method D2369. The acid-functional polyester used is the reaction product of adipic acid and diethylene glycol, exhibits an acid number of 28 and is identified as additive 1 in the following table. The traditional additives evaluated were ethylene glycol, propylene glycol, Texanol, TXIB and 2-ethylhexyl benzoate.

TABLE 2
VOC Values of Typical Coating Additives

| Additive | Weight Percent VOC |
|---|---|
| Ethylene Glycol | 100% |
| Propylene Glycol | 100% |
| Texanol | 100% |
| TXIB | 100% |
| 2-Ethylhexyl Benzoate | 70% |
| Additive 1 | 0.60% |

### EXAMPLE 3

This example compares the improvement in package stability, i.e. resistance to gelation during freeze-thaw cycling imparted to a commercially available zero VOC coating by 1) a polyester of this invention and 2) ethylene and propylene glycols, two conventional additives used for this purpose. The coating was Glidden® Evermore® Interior Latex Enamel Semi-gloss, Pure-white. The acid-functional polyester used was the reaction product of adipic acid and diethylene glycol identified as Additive 1 in the preceding Example 2. The same coating containing ethylene glycol or propylene glycol were evaluated for comparative purposes.

Resistance of the compositions to gelation during freeze-thaw cycling was determined by filling a 2 oz.-capacity jar ¾ full with a sample of the composition to be evaluated. The samples were then placed in a freezer at −10° C. for a minimum of 16 hours, following which they were conditioned by a 16-hour exposure to 25° C., the equivalent of one freeze-thaw cycle. After conditioning, the sample was examined and rated for thickness, consistency and the presence of clumps of material. The samples were rated from 0 to 10 using the scale summarized in Table 4.

TABLE 3
Resistance to Gelation During Freeze-thaw Cycling

| | | Freeze-thaw Cycle | | | | |
|---|---|---|---|---|---|---|
| Additive | Weight % Additive | 1 | 2 | 3 | 4 | 5 |
| Control (no | 0 | 0 | 0 | 0 | 0 | 0 |
| additive) | | | | | | |
| Propylene glycol | 1 | 0 | 0 | 0 | 0 | 0 |
| | 3 | 0 | 0 | 0 | 0 | 0 |
| | 5 | 0 | 0 | 0 | 0 | 0 |
| | 7 | 10 | 10 | 10 | 10 | 10 |
| Ethylene glycol | 1 | 0 | 0 | 0 | 0 | 0 |
| | 3 | 0 | 0 | 0 | 0 | 0 |
| | 5 | 4 | 4 | 2 | 2 | 2 |
| | 7 | 10 | 10 | 10 | 10 | 8 |
| Additive 1 | 1 | 0 | 0 | 0 | 0 | 0 |
| | 3 | 10 | 10 | 10 | 10 | 8 |
| | 5 | 10 | 10 | 10 | 8 | 8 |
| | 7 | 10 | 10 | 10 | 10 | 8 |

TABLE 4
Freeze-thaw Cycling Rating Scale

| Rating | Description |
|---|---|
| 10 | no change |
| 9 | very slightly thickened |
| 8 | slightly thickened |
| 7 | Thickened |
| 6 | moderately thickened |
| 5 | thickened with minor gellation |
| 4 | thickened with moderate gellation |
| 3 | thickened with major gellation |
| | extremely viscous and/ or extreme |
| 2 | gellation |
| 1 | caulk like, but still fluid |
| 0 | completely gelled non-fluid |

The data in table 3 demonstrates that 3 of the 4 samples evaluated in the presence of the acid-terminated polyester of this invention improved the resistance to gelation during freeze-thaw cycling of the formulation significantly. In only one instance, namely 7% propylene glycol, was the performance of the formulation improved over the polyester of this invention.

### EXAMPLE 4

This example compares the coalescing efficiency of an acid-functional polyester of this invention with that of conventional plasticizers/coalescing aids. The polyester used is identified as “Additive 1” in the preceding Table 1 and in Table 5.

The efficiency of the polyester of this invention is determined by blending it into an architectural coating formulation at 1%, 3% and 7% of the formulation weight. A mixture of the mono- and dibenzoates of diethylene and dipropylene glycols available as Velate® 375 is then blended in at increasing concentrations until the resulting formulation will form a continuous film at a 6 mil wet thickness and 4.4° C. The minimum concentration of the benzoate mixture required to form the continuous film is listed in Table 5.

TABLE 5
Velate ® 375 Level Required For a Continuous Film

| | Manufacturer | A | E | F | G |
|---|---|---|---|---|---|
| Grind | | | | | |
| Water | | 70.9 | 70.9 | 70.9 | 70.9 |
| Kathon ™ LX 1.5% | Rohm and Haas | 1.0 | 1.0 | 1.0 | 1.0 |
| Natrosol ® 250 MBR | Aqualon | 0.5 | 0.5 | 0.5 | 0.5 |
| Tamol ™ 2001 | Rohm and Haas | 8.9 | 8.9 | 8.9 | 8.9 |
| Triton ™ CF-10 | Dow | 1.0 | 1.0 | 1.0 | 1.0 |
| BYK ® 024 | Byk-Chemie | 1.0 | 1.0 | 1.0 | 1.0 |
| Aqueous Ammonia | | 1.5 | 1.5 | 1.5 | 1.5 |
| (28%) | | | | | |
| Ti-Pure R-706 | DuPont | 225.0 | 225.0 | 225.0 | 225.0 |
| Minex 10 | Unimin | 20.0 | 20.0 | 20.0 | 20.0 |
| Letdown | | | | | |
| Triton ® X-100 | Dow | 4.5 | 4.5 | 4.5 | 4.5 |
| Fungitrol ® 720 | International Specialty | 8.0 | 8.0 | 8.0 | 8.0 |
| | Products | | | | |
| Rhoplex HG 706 | Rohm and Haas | 531.0 | 531.0 | 531.0 | 531.0 |
| Ropaque Ultra | Rohm and Haas | 30.0 | 30.0 | 30.0 | 30.0 |
| Water | | 44.8 | 44.8 | 44.8 | 44.8 |
| Velate 375 | Velsicol Chem. | 6.0 | 4.5 | 4.0 | 3.5 |
| Acrysol RM 2020 NPR | Rohm and Haas | 20.0 | 20.0 | 20.0 | 20.0 |
| Acrysol RM 8W | Rohm and Haas | 7.0 | 7.0 | 8.0 | 7.0 |
| BYK ® 024 | Byk-Chemie | 3.0 | 3.0 | 3.0 | 3.0 |
| Water | | 61.8 | 53.0 | 35.3 | |
| Additive 1 | Velsicol Chem. | | 10.5 | 31.5 | 73.5 |
| Water | | 3.3 | 4.9 | 4.5 | 5.4 |
| Total | | 1049.2 | 1051.0 | 1054.4 | 1060.5 |

The data in table 5 demonstrate the coalescing ability of the polyester of this invention by the decrease in the concentration of the prior art coalescent, a mixture of benzoate esters (Velate® 375), required to forms a continuous film as the concentration of a polyester of the present invention (additive 1) is increased.

That which is claimed is:

1. A low- or zero VOC aqueous film-forming composition exhibiting properties characteristic of compositions with higher VOC levels, said compositions comprising
A. at least one emulsified or dispersed film-forming organic polymer;
B. as a plasticizing and property improving additive, from 1 to 200 weight percent, based on said organic polymer, of a polyester exhibiting a weight average molecular weight of from 1,000 to 100,000 and including repeating units of the general formula —OR¹O(O)CR²C(O)— and terminal units of at least one general formula selected from the group consisting of —O(O)CR²C(O)OX and —OR¹⁰H, wherein R¹ is at least one member selected from the group consisting of linear and branched alkylene radicals containing from 2 to 10 carbon atoms and —(R³O)ₙR³—, R² is at least one member selected from the group consisting of linear and branched alkylene containing from 1 to 10 carbon atoms and the isomeric phenylenes, R³ is at least one member selected from the group consisting of linear and branched alkyl radicals containing from 2 to 8 carbon atoms, n is an integer from 1 to 4, inclusive; and X is selected from the group consisting of hydrogen, an alkali metal and NH₄⁺; and
C. water;
wherein properties enhanced by said additive include extended open time, package stability, the ability of said composition to coalesce at temperatures at or below the minimum film-forming temperature of said organic polymer and enhancement of the application properties of said composition.

2. A composition according to claim 1 wherein R¹ contains from 4 to 8 carbon atoms, R² is selected from the group consisting of linear alkylene containing from 4 to 8 carbon atoms and the isomeric phenylenes, R³ is ethylene or isopropylene, n is 2 or 3, said film-forming organic polymer is at least one member selected from the group consisting of homopolymers and copolymers of acrylic and methacrylic acid esters, copolymers of these esters with styrene, vinyl monomers, and ethylene; vinyl acetate-ethylene copolymers, polyurethanes, epoxide polymers, and epoxy-modified acrylic polymers; the weight average molecular weight of said polyester is from 3,000 to 6,000 and the concentration of said polyester is from 1 to 50 percent, based on the weight of said film-forming polymer.

3. A composition according to claim 2 wherein said composition is selected from the group consisting of paints, industrial coatings, caulks, sealants, inks, and overprint varnishes and said composition further comprises at least one organic property improving additive selected from the group consisting of dihydric alcohols, glycols, oligomeric glycols, esters of said alcohols and glycols, and ethers.

4. A composition according to claim 1 wherein said film-forming polymer is selected from the group consisting of homopolymers and copolymers of acrylic and methacrylic acid esters, copolymers of said esters with vinyl compounds, copolymers of said esters with styrene and vinyl acetate/ethylene copolymers.

5. A composition according to claim 1 wherein the properties of a film formed from said composition that are enhanced by said additive are selected from the group consisting of resistance to scrubbing, solvents and salt fog, wettability, wet-edge, leveling, gloss development, adhesion and toolabilty.

6. A method for enhancing the properties of films formed using low or zero VOC aqueous film-forming compositions containing at least one film-forming polymer, said method comprising utilizing a composition comprising
A. at least one emulsified or dispersed film-forming organic polymer;
B. as a plasticizing and property-improving additive, from 1 to 200 weight percent, based on said organic polymer, of a polyester exhibiting a weight average molecular weight of from 1,000 to 100,000 and including repeating units of the general formula —OR¹O(O)CR²C(O)— and terminal units of at least one general formula selected from the group consisting of —(O)CR²C(O)OX and —OR¹OH, wherein R¹ is at least one member selected from the group consisting of linear and branched alkylene radicals containing from 2 to 10 carbon atoms and —(R³O)ₙR³—, R² is at least one member selected from the group consisting of linear and branched alkylene containing from 1 to 10 carbon atoms and the isomeric phenylenes, R³ is at least one member selected from the group consisting of linear and branched alkyl radicals containing from 2 to 8 carbon atoms, n is an integer from 1 to 4, inclusive, and X is hydrogen, an alkali metal or NH₄⁺; and
C. water;
wherein the properties enhanced by said additive include but are not limited to extended open time, greater package stability, the ability of said composition to coalesce at temperatures at or below the minimum film-forming temperature of said organic polymer and enhancement of the application properties of said composition.

7. A method according to claim 6 wherein R¹ contains from 4 to 8 carbon atoms, R² is linear alkylene containing from 4 to 8 carbon atoms, R³ is ethylene or isopropylene, n is 2 or 3, said film-forming organic polymer is at least one member selected from the group consisting of homopolymers and copolymers of acrylic and methacrylic acid esters, copolymers of acrylic and methacrylic acid esters with styrene, vinyl monomers or ethylene, vinyl acetate-ethylene copolymers, polyurethanes, epoxide polymers, epoxide-modified acrylic polymers; the weight average molecular weight of said polyester from 3,000 to 6,000 and the concentration of said polyester is from 1 to 50 percent, based on the weight of said film-forming polymer.

8. A method according to claim 7 wherein said composition is selected from the group consisting of paints, industrial coatings, caulks, sealants, inks, and overprint varnishes, and said composition further comprises at least one organic property improving additive selected from the group consisting of dihydric alcohols, glycols, oligomeric glycols, esters of said alcohols and glycols, and ethers.

9. A method according to claim 8 wherein said film-forming organic polymer is selected from the group consisting of homo- and copolymers of acrylic and methacrylic acid esters, copolymers of said esters with vinyl compounds, copolymers of said esters with styrene and vinyl acetate/ethylene copolymers.

10. A method according to claim 9 wherein the properties of a film formed from said composition that are enhanced by said additive are selected from the group consisting of resistance to scrubbing, solvents and salt fog, wettability, wet-edge, leveling, gloss development, adhesion and toolabilty.

11. A method for preparing a low or zero VOC plasticized aqueous polymer composition, said method comprising blending to homogeneity ingredients comprising
A. at least one emulsified or dispersed film-forming organic polymer;
B. as a plasticizing and property improving additive, from 1 to 200 weight percent, based on said organic polymer, of a polyester exhibiting a weight average molecular weight of from 1,000 to 100,000 and including repeating units of the general formula —OR¹O(O)CR²C(O)— and terminal units of at least one general formula selected from the group consisting of —OR¹O—(O)CR²C(O)OX and OR¹OH, wherein R¹ is at least one member selected from the group consisting of linear and branched alkylene radicals containing from 2 to 10 carbon atoms and —(R³O)ₙR³—, R² is at least one member selected from the group consisting of linear and branched alkylene containing from 1 to 10 carbon atoms and the isomeric phenylenes, R³ is at least one member selected from the group consisting of alkylene radicals containing from 2 to 8 carbon atoms, n is an integer from 1 to 4, inclusive and X is selected form the group consisting of hydrogen, an alkali metal and NH₄⁺; and
C. water.

12. A method according to claim 11 wherein R¹ is contains from 4 to 8 carbon atoms, R² is linear alkylene containing from 4 to 8 carbon atoms, R³ is ethylene or isopropylene, n is 2 or 3, said film-forming polymer is at least one member selected from the group consisting of homopolymers and copolymers of acrylic and methacrylic acid esters, copolymers of these esters with styrene, vinyl monomers, and ethylene; vinyl acetate-ethylene copolymers, polyurethanes, epoxide polymers, epoxy-modified acrylic polymers, the weight average molecular weight of said polyester is from 3,000 to 6,000 and the concentration of said additive is from 1 to 50 weight percent, based on the weight of said film-forming polymer.

13. A method according to claim 12 wherein said composition is selected from the group consisting of paints, industrial coatings, caulks, sealants, inks, and overprint varnishes and said composition further comprises at least one organic property improving additive selected from the group consisting of dihydric alcohols, glycols, oligomeric glycols, esters of said alcohols and glycols, and ethers.

14. A method according to claim 13 wherein said film-forming polymer is selected from the group consisting of esters of acrylic and methacrylic acids and alcohols containing from 1 to 8 carbon atoms, copolymers of said esters with vinyl compounds, ethylene and styrene, and vinyl acetate/ethylene copolymers.

15. A method according to claim 14 wherein the properties of a film formed from said composition that are improved by said organic compound are selected from the group consisting of resistance to scrubbing, solvents and salt fog, wettability, wet-edge, leveling, gloss development, adhesion, and toolability.

16. A solid substrate coated with a film of a coalesced low or zero VOC aqueous film-forming composition exhibiting properties of compositions with higher VOC levels, wherein said composition comprises:
A. at least one emulsified film-forming organic polymer;
B. as a plasticizer and property-enhancing additive, from 1 to 200 weight percent, based on said organic polymer, of a polyester exhibiting a weight average molecular weight of from 1,000 to 13,000 and including repeating units of the general formula —OR¹O(O)CR²C(O)— and terminal units of at least one general formula selected from the group consisting of —OR¹O—(O)CR²C(O)OX and OR¹OH, wherein R¹ is at least one member selected from the group consisting of linear and branched alkylene radicals containing from 2 to 10 carbon atoms and —(R³O)ₙR³—, R² is at least one member selected from the group consisting of linear and branched alkylene containing from 1 to 10 carbon atoms R³ is at least one member selected from the group consisting of linear and branched alkyl radicals containing from 2 to 8 carbon atoms, n is an integer from 1 to 4, inclusive, and X is hydrogen, an alkali metal or NH₄⁺; and
C. water.

17. The solid substrate of claim 16 wherein R¹ contains from 4 to 8 carbon atoms, R² is linear alkylene containing from 4 to 8 carbons, R³ is ethylene or isopropylene, n is 2 or 3, said emulsified polymer is selected from the group consisting of homopolymers and copolymers of esters of acrylic and methacrylic acids and alcohols containing from 1 to 8 carbon atoms, copolymers of acrylic and methacrylic acid esters with styrene, vinyl monomers and ethylene, vinyl acetate/ethylene copolymers, epoxide polymers, polyurethanes, epoxide polymers, epoxide-modified acrylic polymers and mixtures containing two or more of said emulsified polymers, the weight average molecular weight of said polyester is from 3,000 to 6,000 and the concentration of said polyester is from 1 to 50 weight percent, based on the weight of said film-forming polymer.

18. The solid substrate of claim 17 wherein composition is selected from the group consisting of paints, industrial coatings, caulks, sealants, inks, and overprint varnishes, and said composition further comprises at least one organic property improving additive selected from the group consisting of dihydric alcohols, glycols, oligomeric glycols, esters of said alcohols and glycols, and ethers.

19. The solid substrate of claim 17 wherein said film-forming polymer is selected from the group consisting of acrylic polymers, vinyl/acrylic copolymers, and styrene/acrylic and vinyl acetate/ethylene copolymers.

20. The solid substrate of claim 19 wherein the properties of a film formed from said composition that are improved by said organic compound are selected from the group consisting of resistance to scrubbing, solvents and salt fog, wettability, wet-edge, leveling, gloss development, adhesion and toolabilty.
